(19) United States
(12) Patent Application Publication
(10) Pub. No.: US 2006/0082709 A1
(43) Pub. Date: Apr. 20, 2006

(54) MULTI-DOMAIN VERTICAL ALIGNMENT LIQUID CRYSTAL PANEL, THIN FILM TRANSISTOR ARRAY SUBSTRATE AND PIXEL STRUCTURE THEREOF

(76) Inventors: Meng-Feng Hung, Changhua County (TW); Chien-Kuo He, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,205

(22) Filed: Jun. 14, 2005

(30) Foreign Application Priority Data
Oct. 15, 2004 (TW) 93131319

(51) Int. Cl. G02F 1/1337

(52) U.S. Cl. 349/129

(57) ABSTRACT

A pixel structure adapted to a multi-domain vertical alignment (MVA) liquid crystal panel is provided. The pixel structure comprises at least a data line, a scan line, a thin film transistor (TFT), a pixel electrode, a shielding electrode and an alignment pattern. The data line and the scan line are disposed on a substrate such that a pixel area is defined. The TFT is disposed within the pixel area and is electrically connected to the data line and the scan line. The pixel electrode is disposed within the pixel area and is electrically connected to the TFT. The shielding electrode is disposed in an area between the pixel electrode and the data line or the pixel electrode and the scan line. The alignment pattern is disposed over the pixel electrode.

### CROSS-REFERENCE TO RELATED APPLICATION

This application claims the priority benefit of Taiwan application serial no. 93131319, filed on Oct. 15, 2004. All disclosure of the Taiwan application is incorporated herein by reference.

### BACKGROUND OF THE INVENTION

1. Field of the Invention

The present invention generally relates to a liquid crystal panel, a thin film transistor array substrate and a pixel structure thereof. More particularly, the present invention relates to a multi-domain vertical alignment (MVA) liquid crystal panel, a thin film transistor (TFT) array substrate and a pixel structure thereof.

2. Description of the Related Art

With the rapid improvement of semiconductor devices and man-machine interface design, the use of multi-media systems in this world is growing fast. In the past, cathode ray tube (CRT) is the choice of display because of its high display quality and low unit price. However, with our increase awareness of environmental protection, CRT no longer meets our criteria because of its bulkiness, high power consumption and possible radiation emission hazards. To resolve this issue, thin film transistor liquid crystal displays (TFT-LCD) have been developed. Because TFT-LCD is light and compact and has a high image display quality without consuming too much power, it has become one of the mainstream display products in the market.

At present, major demands for a liquid crystal display includes a high contrast ratio, a rapid response and a wide viewing angle. To provide a liquid crystal display with a wide viewing angle, the technique for producing a multi-domain vertical alignment (MVA) thin film transistor liquid crystal panel is used.

FIG. 1A is a top view of a conventional multi-domain vertical alignment (MVA) liquid crystal panel. FIG. 1B is a schematic cross-sectional view along sectioning line M-M′ in FIG. 1A. As shown in FIGS. 1A and 1B, the MVA liquid crystal panel 100 comprises at least a thin film transistor (TFT) array substrate 110, a color filter substrate 130 and a liquid crystal layer 150. The TFT array substrate 110 comprises a transparent substrate 112, a plurality of scan lines 114a (only one is shown), a plurality of storage electrodes 114b (only one is shown), an insulating layer 116, a plurality of data lines 118 (only one is shown), a plurality of thin film transistors (TFT) 120 (only one is shown), a passivation layer 122, a plurality of pixel electrodes 124 (only one is shown) and a slit 126 for alignment.

The scan lines 114a and the data lines 118 define a plurality of pixel areas 120a. A thin film transistor 120 is disposed inside each pixel area 120a and is electrically connected to a corresponding data line 118 and a scan line 114a. The passivation layer 122 is formed over the transparent substrate 112 to cover the data line 118 (not shown in FIGS. 1A and 1B). The pixel electrode 124 is disposed within the pixel area 120a and is electrically connected to a corresponding thin film transistor 120. The storage electrode 114b and the pixel electrode 124 serve as the two terminals of a storage capacitor. The slit 126 is formed in the pixel electrode 124.

As shown in FIGS. 1A and 1B, the color filter substrate 130 is disposed over the thin film transistor array substrate 110. The color filter substrate 130 comprises a transparent substrate 132, a color filter film 133a, a black matrix 133b, an electrode film 134 and an protrusion 136 for alignment. The electrode film 134 is disposed on the transparent substrate 132 and the protrusion 136 is disposed on the electrode film 134. The liquid crystal layer 150 is disposed between the TFT array substrate 110 and the color filter substrate 130. The liquid crystal layer 150 comprises a large number of liquid crystal molecules 152.

It should be noted that cross talk might occur between the edge of the pixel electrode 124 and the data line 118. This often leads to a reorientation of the liquid crystal molecules near the edge of the pixel electrode 124 resulting in a non-uniform light distribution. Such abnormality is prominent especially when a black image is displayed because any leakage can be easily observed. To reduce the leakage of light, another type of multi-domain vertical alignment (MVA) liquid crystal panel is described in the following.

FIG. 2 is a schematic cross-sectional view of anther conventional multi-domain vertical alignment (MVA) liquid crystal panel. As shown in FIG. 2, the black matrix (BM) 234 of the color filter substrate 230 in the MVA liquid crystal panel 200 is wider so that the region between the edge of the pixel electrode 124 and the data line 118 where abnormal lighting occurs is shielded. Hence, leakage of light from the panel is minimized. Although increasing the width of the black matrix 234 is effective in preventing light leaking, transparency and brightness of the MVA liquid crystal panel 200 will be significantly reduced.

### SUMMARY OF THE INVENTION

Accordingly, the present invention is directed to a pixel structure, a thin film transistor array substrate and a multi-domain alignment (MVA) liquid crystal panel capable of minimizing the leakage of light and increasing the transparency and brightness of the MVA liquid crystal panel.

According to an embodiment of the present invention, a pixel structure adapted to a multi-domain alignment (MVA) liquid crystal panel is provided. The pixel structure comprises at least a data line, a scan line, a thin film transistor (TFT), a pixel electrode, a shielding electrode and an alignment pattern. The data line and the scan line are disposed on a substrate such that a pixel area is defined. The TFT is disposed within the pixel area and is electrically connected to the data line and the scan line. The pixel electrode is disposed within the pixel area and is electrically connected to the TFT. The shielding electrode is disposed in an area between the pixel electrode and the data line. The alignment pattern is disposed over the pixel electrode.

According to another embodiment of the present invention, a thin film transistor (TFT) array substrate adapted to a multi-domain alignment (MVA) liquid crystal panel is provided. The TFT array substrate comprises at least a plurality of data lines, a plurality of scan lines, a plurality of thin film transistors (TFT), a plurality of pixel electrodes, a plurality of shielding electrodes and an alignment pattern. The data lines and the scan lines are disposed on a substrate such that a plurality of pixel areas are defined. Each thin film transistor is disposed within a pixel area and is electrically connected to a corresponding data line and a corresponding scan line. Each pixel electrode is disposed within a pixel area and is electrically connected to a corresponding thin film transistor. The shielding electrodes are disposed in areas between the pixel electrodes and the data lines. The alignment pattern is disposed over the pixel electrodes.

According to another embodiment of the present invention, a multi-domain vertical alignment liquid crystal panel comprising a thin film transistor array substrate, a color filter substrate and a liquid crystal layer is provided. The thin film transistor array substrate further comprises a plurality of data lines, a plurality of scan lines, a plurality of thin film transistors, a plurality of pixel electrodes, a plurality of shielding electrodes and a first alignment pattern. The data lines and the scan lines are disposed on a substrate to define a plurality of pixel areas. The thin film transistors are disposed inside the respective pixel areas. Each thin film transistor is electrically connected to a corresponding data line and a scan line. Each pixel electrode is disposed inside the pixel area and electrically connected to a corresponding thin film transistor. The shielding electrodes are disposed in areas between the data lines and the pixel electrodes. The first alignment pattern is disposed over the pixel electrodes. Besides, the color filter substrate is disposed over the thin film transistor array substrate. The color filter substrate further comprises an electrode film and a second alignment pattern. The liquid crystal layer is disposed between the thin film transistor array substrate and the color filter substrate.

In brief, the pixel structure, the thin film transistor array substrate and the multi-domain vertical alignment liquid crystal panel of the present invention deploys a shielding electrode between the data line and the pixel electrode. This effectively reduces any cross talk between the edge of the pixel electrode and the data line. Furthermore, because a wide shielding black matrix for reducing stray light is no longer required, overall transparency and brightness level of the liquid crystal panel can be increased.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a top view of a conventional multi-domain vertical alignment (MVA) liquid crystal panel.

FIG. 1B is a schematic cross-sectional view along sectioning line M-M′ in FIG. 1A.

FIG. 2 is a schematic cross-sectional view of anther conventional multi-domain vertical alignment (MVA) liquid crystal panel.

FIG. 3A is a top view of a multi-domain vertical alignment (MVA) liquid crystal panel according to one preferred embodiment of the present invention.

FIG. 3B is a schematic cross-sectional view along sectioning line N-N′ in FIG. 3A.

FIG. 4A is a top view of a multi-domain vertical alignment (MVA) liquid crystal panel having a U-shaped shielding electrode according to one preferred embodiment of the present invention.

FIG. 4B is a top view of a multi-domain vertical alignment (MVA) liquid crystal panel having a U-shaped shielding electrode according to one preferred embodiment of the present invention.

FIG. 4C is a top view of a multi-domain vertical alignment (MVA) liquid crystal panel having a rectangular-shaped shielding electrode according to one preferred embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

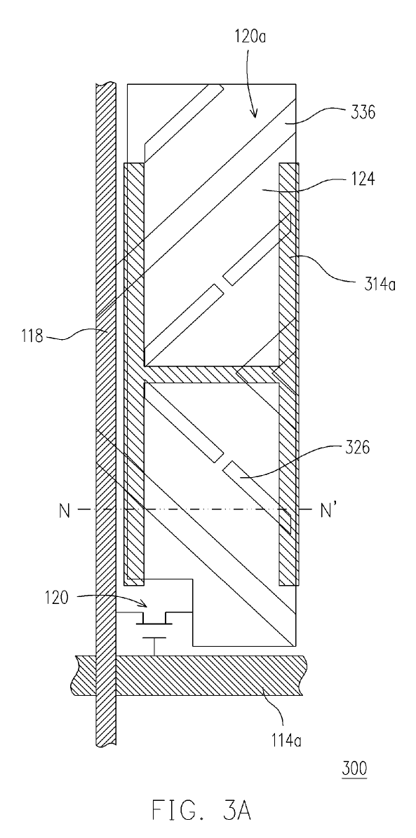

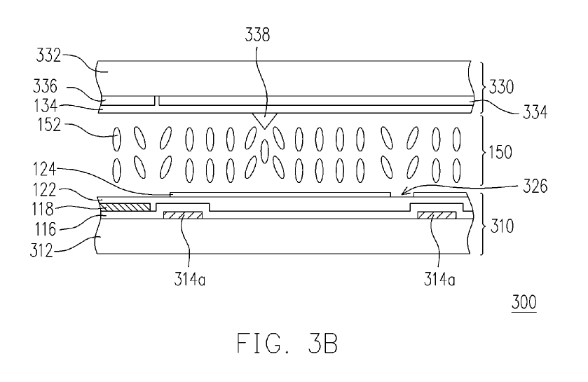

FIG. 3A is a top view of a multi-domain vertical alignment (MVA) liquid crystal panel according to one preferred embodiment of the present invention. FIG. 3B is a schematic cross-sectional view along sectioning line N-N′ in FIG. 3A. As shown in FIGS. 3A and 3B, the multi-domain vertical alignment (MVA) liquid crystal panel 300 comprises at least a thin film transistor (TFT) array substrate 310, a color filter substrate 330 and a liquid crystal layer 150. The TFT array substrate 310 comprises at least a substrate 312, a plurality of scan lines 114a (only one is shown), a plurality of shielding electrodes 314a (only one is shown), an insulating layer 116, a plurality of data lines 118 (only one is shown), a plurality of thin film transistors (TFT) 120 (only one is shown), a passivation layer 122, a plurality of pixel electrodes 124 (only one is shown) and an alignment pattern 326. The substrate 312 is a transparent substrate fabricated using from glass or plastic material, for example.

The scan lines 114a and the data lines 118 are disposed on the substrate 312 to define a plurality of pixel areas 120a. The thin film transistors 120 are disposed within various pixel areas 120a. Each thin film transistor is electrically connected to a corresponding data line 118 and a data line 114a. The passivation layer 122 is disposed over the substrate 312 to cover the data lines 118. The pixel electrodes 124 are disposed inside various pixel areas 120a. Each pixel electrode 124 is electrically connected to a corresponding thin film transistor 120. The alignment pattern 326 is disposed over the pixel electrodes 124. In one embodiment of the present invention, the alignment pattern 326 may be slits within the pixel electrodes 124 or protrusions on the surface of the pixel electrodes 124.

The shielding electrodes 314a are disposed in areas between the data lines 118 and the pixel electrodes 124. Furthermore, the shielding electrodes 314a are electrically isolated from the data lines 118 through an insulating layer 116, and the data lines 118 are electrically isolated from the pixel electrodes 124 through the passivation layer 122. The shielding electrodes 314a shield against any voltage variation in the data lines 118 and prevent any electrical coupling between the pixel electrodes 124 and the data lines 118. In the present embodiment, for each pixel region, the shielding electrode 314a may also serve as one of the electrodes of a storage capacitor and the pixel electrode 124 above may serve as the other electrode of the storage capacitor. The dielectric layer (for example, the passivation layer 122 and the insulating layer 116) between the shielding electrode 314a and the pixel electrode 124 may serve as a capacitor dielectric layer.

The color filter substrate 330 is disposed over the TFT array substrate 310. The color filter substrate 330 comprises at least a substrate 332, a color filter film 334 and a black matrix 336. Furthermore, an electrode film 134 and an alignment pattern 338 are disposed on the color filter substrate 330. The color filter film 334 and the black matrix 336 are disposed on the substrate 332. The color filter film 334 is disposed within the area (not shown) enclosed by the black matrix 336. The electrode film 134 is disposed over the color filter film 334 and the black matrix 336, and the alignment pattern 338 is disposed over the electrode film 134. In one embodiment of the present invention, the alignment pattern 338 may be slits within the pixel electrode 134 or protrusions on the surface of the pixel electrode 134, for example.

In addition, the liquid crystal layer 150 is disposed between the TFT array substrate 310 and the color filter substrate 330. The liquid crystal layer 150 comprises a large number of liquid crystal molecules 152.

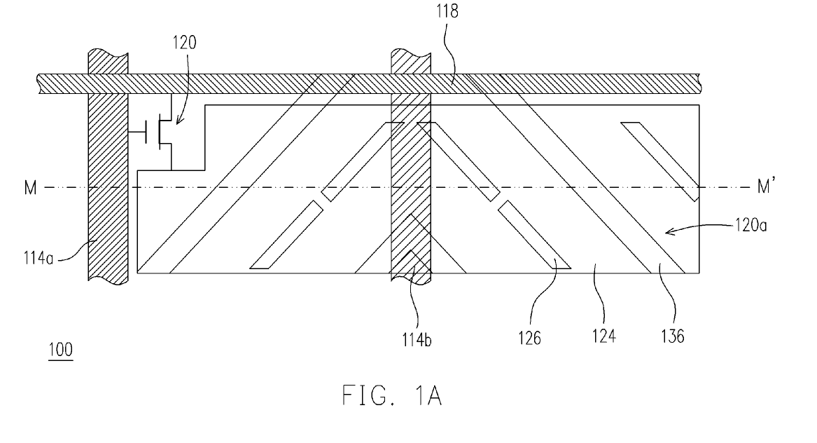

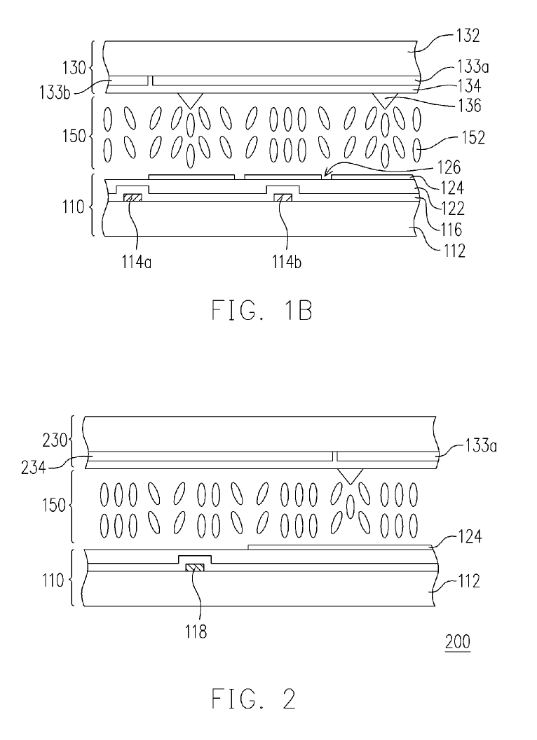

It should be noted that a common stabilizing voltage is applied to the shielding electrode 314a between the data line 118 and the pixel electrode 124. Hence, the shielding electrode 314a can shield the pixel electrode 124 against the effect of a voltage variation in the data line 118 and reduce any cross talk between the data line 118 and the pixel electrode 124. In other words, the liquid crystal molecules 152 near the edge of the pixel electrode 124 are more uniformly aligned and hence prevent light leaking from this panel area. Moreover, the shielding electrode 314a may also serve as the electrode of a storage capacitor. When the shielding electrode 314a is used as a storage electrode, the charge storage capacity of the storage capacitor is increased over a storage capacitor having a conventional electrode (the storage electrode 114b in FIG. 1).

As shown in FIG. 3A, the shielding electrode 314a is disposed in an area between the data line 118 and the pixel electrode 124. The shielding electrode 314a further comprises a section disposed in the area between the pixel electrode 124 and the next data line of the pixel structure to form an H-shape layout.

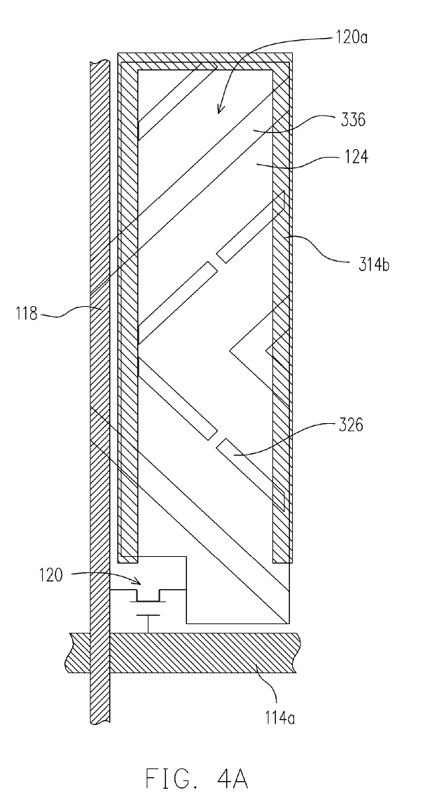

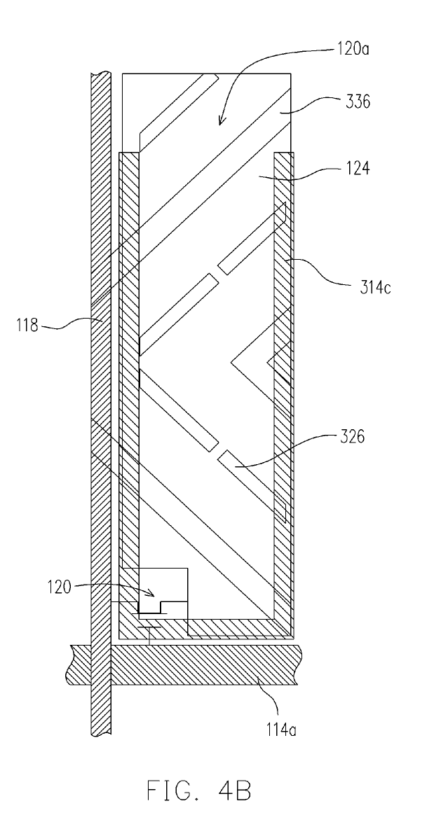

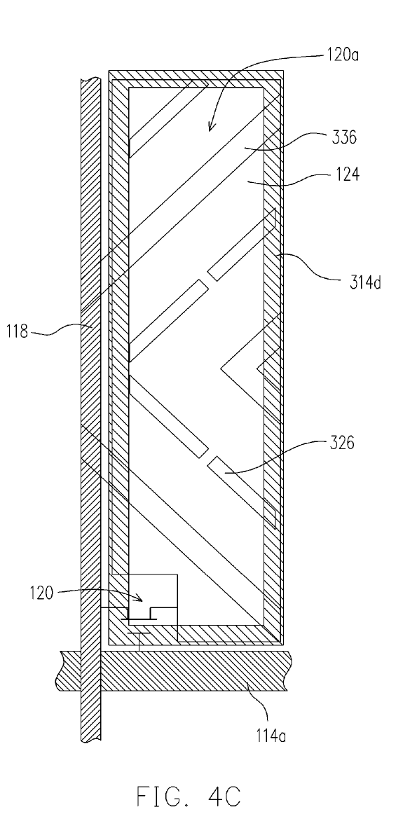

In another embodiment of the present invention, aside from positioning the shielding electrode between the data line and the pixel electrode, further comprises disposing the shielding electrode in an area between the scan line and the pixel electrode. FIG. 4A is a top view of a multi-domain vertical alignment (MVA) liquid crystal panel having a U-shaped shielding electrode according to one preferred embodiment of the present invention. As shown in FIG. 4A, the shielding electrode 314b is disposed in an area between the data line 118 and the pixel electrode 124, between the pixel electrode 124 and the next data line and between the pixel electrode 124 and the next scan line of the pixel structure to form a U-shaped shielding electrode layout.

FIG. 4B is a top view of a multi-domain vertical alignment (MVA) liquid crystal panel having another U-shaped shielding electrode according to one preferred embodiment of the present invention. In the present embodiment, the shielding electrode 314c is disposed in an area between the data line 118 and the pixel electrode 124, between the pixel electrode 124 and the next data line and between the scan line 114a and the pixel electrode 124 to form a U-shaped shielding electrode layout.

FIG. 4C is a top view of a multi-domain vertical alignment (MVA) liquid crystal panel having a rectangular-shaped shielding electrode according to one preferred embodiment of the present invention. In the present embodiment, the shielding electrode 314d is disposed in an area between the data line 118 and the pixel electrode 124, the scan line 114a and the pixel electrode 124, between the pixel electrode 124 and the next data line and between the pixel electrode 124 and the next scan line to form a rectangular-shaped shielding electrode layout.

In summary, the MVA liquid crystal panel of the present invention has a design that effectively reduces any cross talk between the edge of the pixel electrode and a neighboring data line so that stray light from this area due to angular displacement of liquid crystal molecules is minimized. Hence, a narrower black matrix can be used to shield against stray light. Ultimately, the MVA liquid crystal panel can provide a higher light transparency and a brightness level than a conventional liquid crystal panel.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel structure for a multi-domain vertical alignment (MVA) liquid crystal panel, comprising:
a data line and a scan line, disposed on a substrate to define a pixel area;
a thin film transistor, disposed within the pixel area, wherein the thin film transistor is electrically connected to the data line and the scan line;
a pixel electrode, disposed within the pixel area and electrically connected to the thin film transistor;
a shielding electrode, disposed in a area between the pixel electrode and the data line; and
an alignment pattern, disposed over the pixel electrode.

2. The pixel structure of claim 1, wherein the shielding electrode is further disposed in an area between the pixel electrode and the next data line.

3. The pixel structure of claim 1, wherein the shielding electrode is further disposed in an area between the pixel electrode and the scan line.

4. The pixel structure of claim 1, wherein the shielding electrode is further disposed in an area between the pixel electrode and the next scan line.

5. The pixel structure of claim 1, wherein the shielding electrode and the pixel electrode also serve as the electrodes of a storage capacitor.

6. The pixel structure of claim 1, wherein the alignment pattern comprises protrusions formed on the pixel electrode.

7. The pixel structure of claim 1, wherein the alignment pattern comprises slits formed in the pixel electrode.

8. A thin film transistor array substrate for a multi-domain vertical alignment (MVA) liquid crystal panel, the thin film transistor array substrate comprising:
a plurality of data lines and a plurality of scan lines, disposed on a substrate to define a plurality of pixel areas;
a plurality of thin film transistors, disposed inside various pixel areas such that each thin film transistor is electrically connected to a corresponding data line and a scan line;
a plurality of pixel electrodes, disposed inside various pixel areas such that each pixel electrode is electrically connected to a corresponding thin film transistor;
a plurality of shielding electrodes, each shielding electrode is disposed in a area between a corresponding data line and a pixel electrode; and
an alignment pattern, disposed over the pixel electrode.

9. The thin film transistor array substrate of claim 8, wherein the shielding electrodes are further disposed in areas between the scan lines and the pixel electrodes.

10. The thin film transistor array substrate of claim 8, wherein the shielding electrode and the pixel electrode inside each pixel area serve as the electrodes of a storage capacitor.

11. The thin film transistor array substrate of claim 8, wherein the alignment pattern comprises protrusions formed on the pixel electrodes.

12. The thin film transistor array substrate of claim 8, wherein the alignment pattern comprises slits formed in the pixel electrodes.

13. A multi-domain vertical alignment (MVA) liquid crystal panel, comprising:
a thin film transistor array substrate, comprising:
a plurality of data lines and a plurality of scan lines, disposed on a substrate to define a plurality of pixel areas;
a plurality of thin film transistors, disposed inside various pixel areas such that each thin film transistor is electrically connected to a corresponding data line and a scan line;
a plurality of pixel electrodes, disposed inside various pixel areas such that each pixel electrode is electrically connected to a corresponding thin film transistor;
a plurality of shielding electrodes, each shielding electrode is disposed in a area between a corresponding data line and a pixel electrode;
an alignment pattern disposed over the pixel electrode;
a color filter substrate, disposed over the thin film transistor array substrate, wherein the color filter substrate further comprises an electrode film and a second alignment pattern thereon; and
a liquid crystal layer, disposed between the thin film transistor array substrate and the color filter substrate.

14. The MVA liquid crystal panel of claim 13, wherein the shielding electrodes are further disposed in areas between the scan lines and the pixel electrodes.

15. The MVA liquid crystal panel of claim 13, wherein the shielding electrode and the pixel electrode inside each pixel area serve as the electrodes of a storage capacitor.

16. The MVA liquid crystal panel of claim 13, wherein the first alignment pattern comprises protrusions formed on the pixel electrodes.

17. The MVA liquid crystal panel of claim 13, wherein the first alignment pattern comprises slits formed in the pixel electrodes.

18. The MVA liquid crystal panel of claim 13, wherein the second alignment pattern comprises protrusions formed on the electrode film.

19. The MVA liquid crystal panel of claim 13, wherein the second alignment pattern comprises slits formed in the electrode film.
